(19) United States
(12) Patent Application Publication
(10) Pub. No.: US 2018/0149672 A1
(43) Pub. Date: May 31, 2018

(54) INTENSITY MODULATED FIBER OPTIC ACCELEROMETERS AND SENSOR SYSTEM

(71) Applicant: Fiber Optic Sensor Systems Technology Corporation, Washington, DC (US)

(72) Inventors: Nicholas Lagakos, Silver Spring, MD (US); Dylan Smith, Montgomery Village, MD (US); Patrick Hernandez, Silver Spring, MD (US)

(73) Assignee: Fiber Optic Sensor Systems Technology Corporation, Washington, DC (US)

(21) Appl. No.: 15/365,340

(22) Filed: Nov. 30, 2016

(51) Int. Cl. G01P 15/093

(52) U.S. Cl. CPC G01P 15/093

(57) ABSTRACT

An intensity modulated fiber optic acceleration sensor is disclosed. The sensor includes a fiber bundle, comprising a transmitting optical fiber and at least one receiving optical fiber, and reflector spaced apart from the fiber probe. The reflector is attached to an element that exhibits a physical displacement in response to acceleration, such as a cantilever or a coil spring. The reflector moves in a direction relative to the fiber optic probe in response to acceleration. The amount of light received by the receiving fiber changes in response to the change in distance between the reflective surface and the fiber probe due to acceleration. A fiber optic sensor system for detecting acceleration along multiple planes of an object or objects of interest is disclosed. A triaxial sensor system has fiber optic sensors and may be configured to measure acceleration signals along three axes from a common plane of an object.

### CROSS-REFERENCE TO RELATED APPLICATIONS

The theory of intensity modulated optical fiber sensors, and examples of such sensors, are disclosed in the U.S. Government-owned inventions by Nicholas Lagakos et al., described in U.S. Pat. No. 7,020,354: Intensity Modulated Fiber Optic Pressure Sensor; U.S. Pat. No. 7,149,374: Fiber Optic Pressure Sensor; U.S. Pat. No. 7,379,630: Multiplexed Fiber Optic Sensor System; U.S. Pat. No. 7,646,946: Intensity Modulated Fiber Optic Strain Sensor; U.S. Pat. No. 8,195,013: Miniature Fiber Optic Temperature Sensors, and others (collectively, the “U.S. Government Patents”). The disclosures of the U.S. Government Patents are incorporated herein by reference.

### FIELD OF INVENTION

This invention relates to intensity modulated fiber optic acceleration sensors and a system of fiber optic acceleration sensors.

### BACKGROUND

An accelerometer is a sensing device that measures acceleration. Many commercially available accelerometers are electromechanical devices. These devices may use a sensing element formed of piezo-electric material, which generates a small electrical current or voltage when acceleration is sensed. This small electrical signal is usually amplified. Other approaches use a capacitive approach, whereby the change in the gap between two charged plates changes the electrical capacitance of the system, producing a measurable voltage output. Electromechanical sensor systems can be bulky, expensive, subject to electromagnetic interference (EMI), and have higher error rates at low frequencies. Remote control and multiplexing of these sensors can also be difficult.

The use of fiber optic sensing approaches is an alternative that addresses the accuracy, EMI sensitivity, safety, size, and robustness concerns inherent with existing electromechanical measurement devices in various applications. Since fiber optics use light rather than electricity as the basis for measurement, a fiber optic sensor is generally insensitive to EMI and is therefore effective in an environment that has a large amount of electromagnetic energy. As a result, fiber optic sensors can be located near or attached to objects or equipment that experience or generate large electro-magnetic fields without negative effects upon either the quality of measurement or upon the functionality of the sensor itself.

In recent years, fiber optics have formed the basis for sensors for the measurement of many different physical phenomena, such as pressure, strain, electromagnetic phenomena, temperature, and others. Optical fiber sensors can use phase, polarity, or intensity modulation approaches. Intensity modulation yields fiber optic sensors that have benefits when compared to electro-mechanical and optical alternatives in terms of sensitivity, simplicity, and total cost. The theory of intensity modulated optical fiber sensors, and examples of such sensors are disclosed in the U.S. Government Patents by Lagakos et al.

The use of an intensity modulated fiber optic sensing approach to measure acceleration provides advantages over alternatives in terms of sensitivity, EMI immunity, simplicity, and cost. The use of multiple sensors allows for the measurement of multiple instances of acceleration or displacement, such as in different directional planes (i.e.—perpendicular X, Y, and Z axes). The ability to employ multiple sensors using a common sensing technique allows for simultaneous measurement of multiple instances of common or different physical phenomena and enables ready comparison of sensor outputs. In addition to providing for a simpler system due to the ability to use common or shared elements, this approach addresses the challenge of aligning measurement outputs that are derived from sensors with differing physical and operating principles and, therefore, differing inherent levels of accuracy, operating ranges, and rates of error.

Therefore, it is an object of this invention to offer a fiber optic acceleration sensor and sensor system that is: highly accurate in the measurement of acceleration; highly sensitive; capable of use in areas with high potential for EMI; physically robust; uses a common sensing technique to measure multiple acceleration signals; and physically compact, simple to construct, install, and operate.

### SUMMARY OF THE INVENTION

An aspect of the invention is directed to fiber optic sensors for measuring acceleration. The embodiments of sensors described herein utilize an intensity modulated fiber optic sensing approach to obtain measurements of acceleration. A disclosed embodiment of a fiber optic acceleration sensor consists of a fiber optic probe comprised of a transmitting fiber and at least one receiving fiber, an element that exhibits a physical displacement in response to acceleration, and a reflective surface that is a part of or is attached to the responsive element, with the fiber optic probe placed proximate to the reflective surface. The acceleration-responsive element may be a cantilever, a spring, or any other material wherein the acceleration force causes a displacement in the element that can be measured. In operation, the force generated by acceleration causes the responsive element to displace in a given direction, and the displacement is translated to a change in the distance between the fiber optic probe and the reflective surface. The change in the distance between the probe and the reflector changes the amount of light received by the receiving fibers, with the change in light received being indicative of the acceleration experienced by the sensor.

Another aspect of the invention is directed to a system of intensity modulated fiber optic sensors for measuring acceleration forces acting upon multiple axes of an object or objects of interest. The disclosed embodiments of the system may include multiple intensity modulated fiber optic acceleration sensors. The disclosed embodiments of the system may be used to obtain simultaneous measurement of multiple acceleration signals with high accuracy in a common system as an alternative to using multiple measuring devices. The disclosed embodiments of the system may enable monitoring the acceleration forces acting upon a single object or multiple objects of interest, which can include acceleration forces experienced along various axes of an object or multiple objects.

The disclosed embodiments of the system provide a means to measure multiple acceleration signals at the same (or approximately the same location). Embodiments of the multiplexed acceleration sensor system can be also constructed so as to use additional fiber optic sensors to obtain measurements of different physical phenomena at the same location or approximately the same location. The disclosed embodiments of the system may include fiber optic sensor systems that measure acceleration, electromagnetic phenomena, pressure, strain, displacement, temperature, or other physical phenomena. This may be useful, for example, to better understand the operating characteristics of equipment used in the generation, transmission, and distribution of electric power or in industrial control applications. Because a large number of sensors may be desirable to take multiple measurements of interest, it is further advantageous to multiplex them in order to reduce the number of total components required to construct the system.

### BRIEF DESCRIPTION OF THE DRAWINGS

FIG. 1 shows an embodiment of a fiber optic acceleration sensor utilizing a cantilever element.

FIG. 2 shows an alternative embodiment of a fiber optic acceleration sensor utilizing an alternative cantilever.

FIG. 3 shows an alternative embodiment of a fiber optic acceleration sensor utilizing a spring coil element.

FIG. 4 shows the voltage output response of the fiber optic acceleration sensor described in FIG. 1 over a range of 0 Hz to 100 Hz.

FIG. 5 shows the voltage output response of a reference displacement sensor over a range of 0 Hz to 100 Hz used to evaluate the fiber optic acceleration sensor described in FIG. 1.

FIG. 6 shows show a demonstration set-up of a fiber optic displacement sensor used to calibrate and test the fiber optic acceleration sensor.

FIG. 7 illustrates an embodiment of a triaxial fiber optic sensor system.

### DETAILED DESCRIPTION OF THE INVENTION

An aspect of the invention is directed to fiber optic acceleration sensors and a system of fiber optic acceleration sensors for taking multiple measurements of acceleration.

The embodiments of fiber optic sensors disclosed use intensity modulation sensing to measure acceleration. The disclosed embodiments of sensors include an optical fiber probe, which includes a transmitting fiber and at least one receiving fiber, the probe being positioned proximate to a reflective surface or body, the reflector is part of or is attached to an element that exhibits a physical displacement in response to acceleration. The element may be a cantilever, a spring coil, or any other element that experiences a displacement in response to acceleration. In operation, the force generated by acceleration causes the element to displace, the displacement translates to a change in the distance between the fiber probe and the reflective surface that is a part of or is attached to the responsive element. The change in distance between the fiber probe and the reflector modulates the amount of light received by the receiving fibers, with the amount of light sensed by the receiving fibers indicative of the acceleration experienced by the sensor.

The embodiments of the system disclosed may include multiple fiber optic acceleration sensors. The disclosed embodiments of the system may provide a means to measure multiple acceleration signals, can be used to simultaneously measure acceleration forces acting upon different planes (i.e.—perpendicular x, y, and z axes) using an intensity modulation measurement approach. In particular, the disclosed embodiments of the system may allow for multiple axes of acceleration inputs to be measured along a common plane of a structure. The embodiments of the system disclosed may allow multiple sensors to measure acceleration forces experienced along multiple axes but along a common plane of an object of interest, enabling the sensor fibers to enter a common enclosure from the same direction, reducing the footprint of the overall sensor system.

The disclosed embodiments of the system may also incorporate measurements of pressure, strain, electromagnetic phenomena, displacement, temperature, or other physical phenomena using other types of fiber optic sensors. The acquisition of multiple measurement inputs from sensors using a common sensing technique allows for simultaneous measurement of multiple instances of common or separate physical phenomena which can be readily compared. In addition to providing for a leaner overall system due to the ability to use common or shared elements, this approach enables measurement using a common sensing technique that can be readily synchronized and compared.

### Operation of Intensity Modulated Fiber Optic Acceleration Sensors

Fiber optic sensors can be used to measure acceleration. The embodiments of fiber optic acceleration sensors disclosed herein utilize an intensity modulation measurement approach.

The sensor may include an optical fiber probe, which includes a transmitting fiber and at least one receiving fiber, a reflective surface or body that is a part of or is attached to an element that exhibits a physical displacement in response to acceleration. The reflective surface is spaced apart from the ends of the fibers and positioned so that light, transmitted through the transmitting fiber, is reflected by the reflective surface into at least one receiving fiber of the fiber optic probe. A light sensing means may be coupled to the second end of the at least one receiving fiber. In operation, light from a light source is launched into the transmitting fiber, propagates through the transmitting fiber and emerges at the end, propagates a short distance from the end of the fiber, and is reflected at least partially by the reflective element back into the receiving fibers; the reflected light then propagates through the receiving fibers, and the light is detected by the light sensing means.

In operation, the acceleration force causes the element responsive to acceleration to displace. The displacement of the element causes a change in the distance between the fiber probe and the reflective surface that is part of or attached to the element. The change in distance modulates the amount of light received by receiving fiber or fibers and detected by the light sensing means. The amount of light detected by the light sensing means is thereby indicative of the acceleration experienced by the element responsive to the acceleration force.

The element responsive to acceleration force can be comprised of, or constructed using, any known means. For example, in some embodiments the element can be a cantilever having one free end, and a second end attached to the sensor housing, allowing the free end of the cantilever to sense acceleration and displace in a direction relative to the optical probe. In other embodiments, the element can be constructed as a dual cantilever, whereby the cantilever is fixed at both ends. Other embodiments include a “cross” cantilever, wherein four cantilevers are used, or a circular cantilever wherein the cantilever acts as a circular diaphragm. In an alternative embodiment, the responsive element can be a spring coil. Alternative constructions of the cantilever design are readily envisioned and present different mechanical properties and operational characteristics, allowing for the sensor to be constructed with greater stability, sensitivity, and sensing range, depending upon the requirements of particular applications.

In envisioned embodiments, the reflective material is not attached directly to the element responsive to acceleration, but rather the responsive element is used to displace a material that is attached to that element, such that the acceleration experienced by the responsive element is translated to the material and thereby causing the second material to displace in response to acceleration. This approach allows for the acceleration experienced by the responsive element in a given direction to be translated into a displacement of a material in an alternative direction. This approach enables, for example, acceleration experienced by the sensor on an “X” axis to be translated to a displacement of a material in the “Y” axis, which can be measured along that “Y” axis.

In disclosed embodiments of the sensor, an element responsive to acceleration is selected, the element has a reflective surface or is attached to a material with a reflective surface, and that reflective surface is positioned proximate to a fiber optic probe. When the element responsive to acceleration is displaced due an acceleration force, that force is translated into a displacement of the reflector relative to the fiber optic probe, changing the distance between the fiber probe end and the reflective surface. The amount of light sensed by the receiving fiber is proportional to the relative change in distance between the reflector and the fiber probe, with the change in light being indicative of acceleration.

The following discussion regarding theoretical aspects of the sensors is provided for means of explanation of cantilever embodiments. A theoretical discussion of spring coil embodiments is presented in later paragraphs. This theoretical discussion is presented without limiting the invention to any particular theory of operation.

For embodiments wherein the responsive element is a cantilever, the acceleration detected by the sensor is derived by measuring the displacement experienced by a cantilever in response to acceleration. Here, a sensor embodiment using a cantilever with one free end and one end affixed to the sensor housing is chosen as an illustrative example. Acceleration can be found using the equation: A=ω²x. Where: A=acceleration, x=the measured displacement, and ω=2πf (where f=frequency). Thus, it can be seen that acceleration can be found as a function of cantilever displacement and frequency.

The single cantilever beam's displacement at the free end can be found as:

$$\frac{{WL}^{3}}{3 EI}$$

Where: W=beam width, L=beam length, E=the material's Young's modulus, and I=the moment of inertia. The deflection of the cantilever is indicative of the displacement experienced by the object to which the accelerometer is attached.

The sensitivity of the sensor is proportional to the displacement experienced by the cantilever, consistent with the following equation:

$$\frac{{mL}^{3}}{{EWt}^{3}}$$

Where: m=mass of the cantilever, L=beam length, E=the material's Young's modulus, W=beam width, and t=the thickness of the cantilever.

From this equation, it is apparent that the dimensional composition, mass of the cantilever, and Young's modulus of the material selected can be pre-determined. Thus, the displacement of the cantilever in response to a given force is knowable. For example, all other aspects of a particular sensor construction being equal, using a material with a relatively higher Young's modulus (such as stainless steel with a Young's modulus of 150×10¹⁰ dynes/cm²) will result in less sensitivity than a sensor using a material with a lower Young's modulus (such as acrylic with a Young's modulus of 5×10¹⁰ dynes/cm²). It can also be seen that the accelerometer's sensitivity is particularly influenced by the cantilever's mechanical construction, particularly the cantilever's length and thickness. This equation also explains the sensor's strongly uniaxial characteristics (i.e., sensing only along a pre-determined axis) as the construction of the cantilever makes the displacement in a given direction substantially higher than any displacement experienced along alternative axes.

The cantilever possesses a mass spring resonance frequency, which is inversely proportional to the sensitivity of the sensor. The mass-spring resonance of a single cantilever with a free end can be found as:

$${f}_{r} = \frac{1}{2} * \frac{{EWt}^{3}}{4 {mL}^{3}}$$

Where: k=the material's spring constant (or stiffness) and m=mass of the cantilever. Taken together, these variables allow for isolation of the acceleration signal by measuring displacement at a given frequency. By comparing the sensitivity equation with the mass-spring resonance equation it is apparent that an increase in the sensitivity of the sensor will result in a lower resonance frequency. The use of alternative constructions, such as a double cantilever approach will also affect the accelerometer's operating characteristics. For example, the use of a double cantilever (affixed to the sensor housing at both ends, with a mass in the middle) will have a substantially higher mass spring resonance frequency and lower sensitivity.

Note that other modes of fiber optic sensors have been developed to measure displacement and acceleration, as described in U.S. Pat. No. 7,792,395 to Lagakos et al., which discloses sensors that also utilize a reflective surface attached to a cantilever. However, the structure and functionality of that sensor is predicated upon the cantilever operating “in plane” or transverse to the ends of the one transmitting and one receiving fibers that constitute the fiber optic probe of the sensor. That is, a cantilever crosses across the plane of the receive fiber due to the force of acceleration detected by that cantilever and the cantilever's motion is across the receive fiber to increase the amount of light received by the fiber. Here, by contrast, a single transmit fiber is surrounded by a multitude of receiving fibers, providing additional sensitivity and the sensing technique is based upon intensity modulation derived as a matter of probe-reflector distance, rather than the theory described in U.S. Pat. No. 7,792,395, whereby measurement is derived based upon only partial reflection of transmitted light.

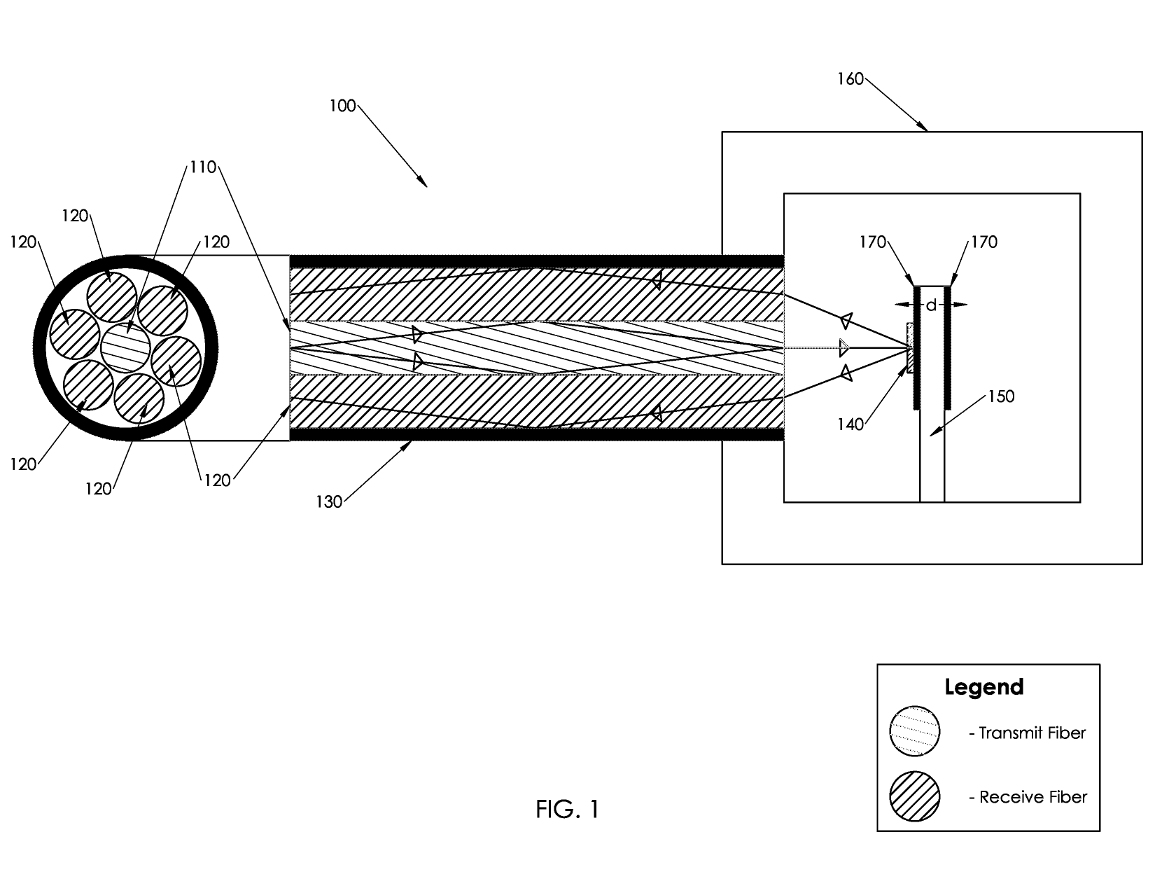

FIG. 1 shows an embodiment of a fiber optic acceleration sensor 100. In this embodiment, a cantilever with a free end is used as the element responsive to acceleration, a reflective surface attached to the cantilever, and a fiber probe to form an acceleration sensor. A fiber bundle featuring a transmitting fiber 110 and at least one receiving fiber 120 having a first and second ends is placed adjacent to a reflective surface 140. The fiber bundle may feature a multitude of receiving fibers 120 disposed around the transmitting fiber with each receiving fiber having first and second ends. The first end of the transmitting fiber may have a polished finish and the second end is coupled to a light source (not shown). The fiber ends of the at least one receiving fibers may have a polished finish and the second end(s) is coupled to a light detecting means (not shown). The sensor may use an LED emitting at 850 μm as the light source with a silicon PIN diode as the light sensing element (not shown). However, other light sources, such as laser diodes, and other light sensing elements may be used.

The fiber bundle is inserted into a tubing 130 so the fiber bundle consisting of the transmitting fiber 110 and the receiving fibers 120 are contained within the tube, forming a probe. Here, six receiving fibers 120 are used in the fiber probe. The fiber probe is positioned such that the first end of the transmitting fiber and the first end of each receiving fiber is adjacent to the reflective surface 140 of a cantilever 150 that will exhibit a physical displacement when subjected to acceleration, with space between the fiber ends and the reflective surface of the material.

The cantilever 150 has a fixed end and a free end. The fixed end of the cantilever is attached to a housing 160, and the other end of the cantilever is left free within the enclosure of the housing. The reflective surface 140 is a part of, or is attached to, the cantilever 150 at the cantilever's free end. The reflective surface 140 is positioned such that is proximate to the end of the fiber probe. A housing 160 encloses the end of the fiber probe 130, the reflective surface 140, and the cantilever 150, with the housing affixed to the object or structure to be measured for acceleration. The housing can be sealed to prevent contaminants from entering the enclosure.

The cantilever 150 can include a mass 170 at the free end of the cantilever, which has the effect of lowering the resonance frequency of the cantilever by a controlled amount, as shown by the mass spring resonance equation above. The fiber probe 130 is affixed to the housing 160 so motion of the sensor base is translated to the sensor 100. Because the cantilever 150 and the fiber probe 130 are both affixed to the base, the distance between the reflector 140 and fiber probe 130 are initially fixed. The acceleration experienced by the sensor is therefore translated to the sensor's cantilever element, isolating the acceleration force, which is expressed as a displacement of the cantilever. The amount of light received by the receiving fibers indicates a relative acceleration experienced by the sensor.

An embodiment of the fiber optic accelerometer described in FIG. 1 may be constructed as follows. A cantilever 150, is constructed of a mylar strip measuring 0.10″ thick, 0.125″ wide, and 0.50″ long. A mass 170 can be added to the free end of the mylar cantilever beam. In this embodiment, a 1 g total mass 170 is added to the wide side of the cantilever 150. The cantilever has a fixed end that is attached to the sensor housing 160. Here, the sensor housing is constructed of aluminum, but any other material may be used. The cantilever has a reflective surface or body 140 attached to the material that is used to add mass to the cantilever. The reflective surface can be a metal (aluminum, beryllium, chromium, copper, gold, molybdenum, nickel, platinum, rhodium, silver, tungsten, and/or an alloy of any of these or other reflective metals) that is attached to the cantilever. The reflective surface may be attached to the cantilever by any known means, including by the use of an epoxy, or by evaporation or electroplating.

The type of fiber employed in the probe is generally an optical fiber having a core that is preferably made of glass. The cladding may be plastic or some other material. In a preferred embodiment fibers with a high numerical aperture are used. Generally fibers with a numerical aperture of >0.2 are employed. A high numerical aperture provides for greater efficiency in the coupling and transmission of light. The fiber may be a multimode fiber. Multimode fibers and fibers featuring high numerical apertures are not required, however. When employed in systems that have a great distance between the source and the reflective side of the material a fiber having a high numerical aperture is not critical. The transmitting and receiving optical fibers in the sensors can be selected based on the sensor design and desired application, and are not limited by the material, numerical aperture, diameters, or number of fibers of the specific examples herein.

Generally, multimode fibers with a combination of a thick core and thin clad fiber are preferred. Light incident on clad is lost, thus it is beneficial for the core to be as close in proximity to the outer perimeter of the clad as possible to ensure efficient light coupling in the core. Light coupling within the fiber is maximized with a thick core thin clad structure. This however, does not limit the use of fibers in this device to multimode fibers with thick core thin cladding structures. Varying degrees of effectiveness and light coupling are possible with other fiber configurations.

According to one embodiment of the sensor, one end of the fiber has a polished finish and the opposite end of the transmitting fiber is coupled to a light source (not shown). The first ends of the receiving fiber or fibers also feature a polished finish, with the opposite ends coupled to the light sensing element (not shown). The optical fiber may feature a 200 μm glass core, and 230 μm plastic clad, a 500 μm Tefzel plastic coating, with a numerical aperture of approximately 0.37. The plastic coating is stripped and epoxy is applied to the fibers so the fibers form a symmetric bundle. The fiber bundle is inserted into a tubing 130 so the fiber bundle is contained within the tube, forming a probe.

The fiber probe 130 is positioned such that the first end of the transmitting fiber and the first end of each receiving fiber are adjacent to the reflective surface with space between the first fiber end of both the transmitting and receiving fibers and the reflective surface. The material chosen can be polished. The reflector 140 can be a part of the cantilever 150 itself or a reflective body or coating, layer, or other reflective material that is comprised of a reflective material such as a metal (aluminum, beryllium, chromium, copper, gold, molybdenum, nickel, platinum, rhodium, silver, tungsten, and/or an alloy of any of these or other reflective metals) that is attached to the cantilever. A broad dynamic sensitivity maximum has been found for a probe-reflector separation between 180 and 250 μm for a seven-fiber sensor using one transmitting fiber and six receiving fibers, but other applications may make a different mode of construction (i.e.—the number of fibers utilized) desirable. Any combination of fibers may be used to form the probe.

The light sensing element may be a silicon PIN diode, and the light source may be an LED. LEDs represent an efficient way to launch light into the fiber probe. LEDs are commercially available, generally low cost, and feature low noise operation in a fiber system. LEDs also tend to be very stable over extended periods of time. Laser diodes may also be used as the light source, although they increase the expense and complexity of the system. Current laser diodes also tend to introduce additional noise to the sensor measurement system. One suitable LED for use as a light source is an Optek OPF370A LED emitting light at 850 μm wavelength. The light source is coupled to the transmitting fiber and the light sensing element is arranged to receive light from the receiving fiber or fibers of the sensors.

In operation, the force generated by acceleration causes a displacement in the cantilever. The cantilever displaces in the direction of the fiber optic probe changing the distance between the reflector and the fiber optic probe. The light launched from the light source into the transmitting fiber propagates through the fiber and is reflected by the reflective surface attached to the cantilever, is received by the receiving fibers and is detected by the light detecting means. This light detected by the light detecting means is indicative of acceleration experienced by the sensor.

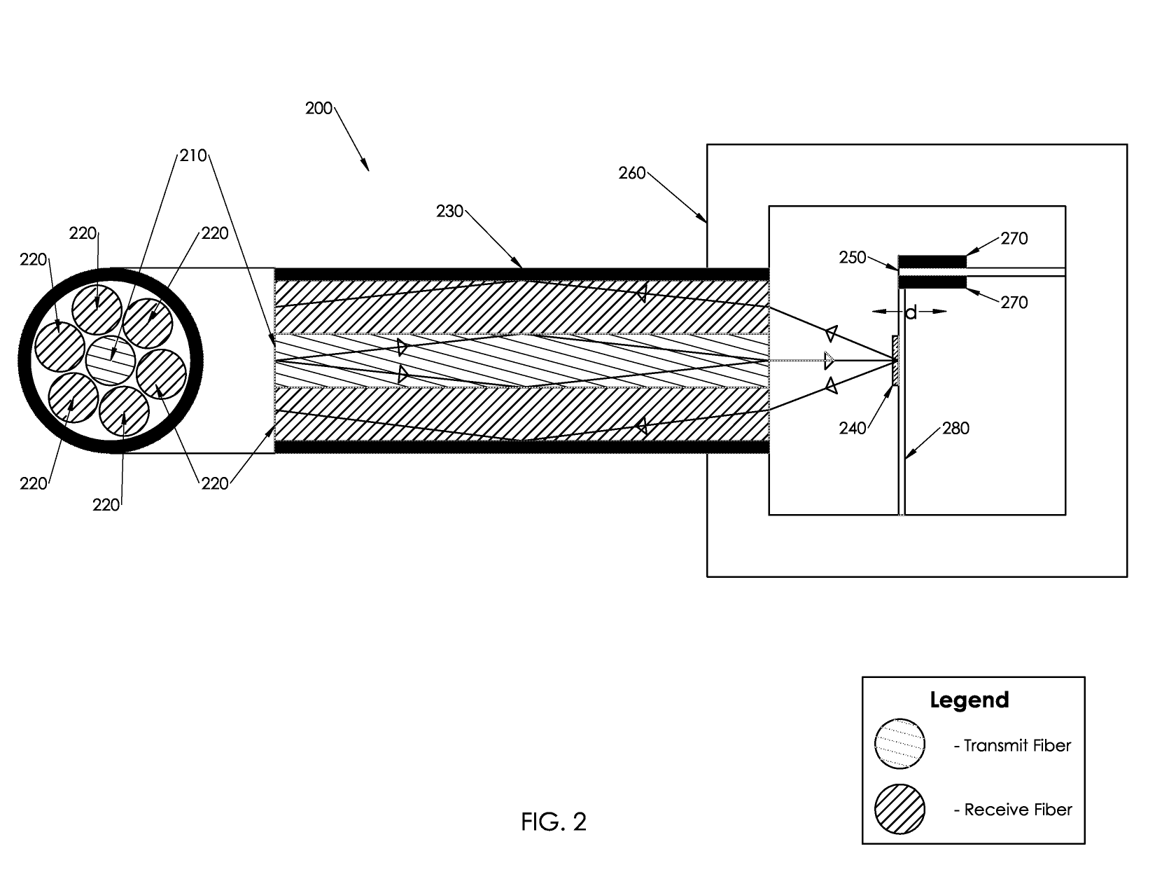

FIG. 2 presents an alternative embodiment of a fiber optic accelerometer 200. In this embodiment, the reflective material 250 is not attached directly to the cantilever, but rather the cantilever is used to displace a material 280 that is anchored to the free end of the cantilever, perpendicular to the cantilever and anchored to the sensor housing 260 at the other end. Thus, the displacement of the cantilever is translated to a direction perpendicular to motion of the cantilever. The material can be reflective itself, such as mylar, or can be a material with a reflective surface attached or affixed to it. The cantilever can have a mass 270 at its free end.

The force generated by the acceleration causes the cantilever 250 to displace, which is then translated to the material 280 anchored to the free end of the cantilever. The displacement of the cantilever causes a displacement in the material 280 that changes the distance between the sensor's reflective surface 240 and the fiber optic probe 230, indicative of acceleration. This embodiment allows for the translation of an acceleration signal onto an alternative axis (i.e., translating acceleration sensed on the y axis into a displacement in the material on the x axis). Restated, the acceleration experienced by the sensor is translated to the sensor's cantilever element, isolating for acceleration, which is then translated to a material 280 that displaces in a direction perpendicular to the acceleration, changing the distance between the reflective surface 240 and the fiber optic probe 230.

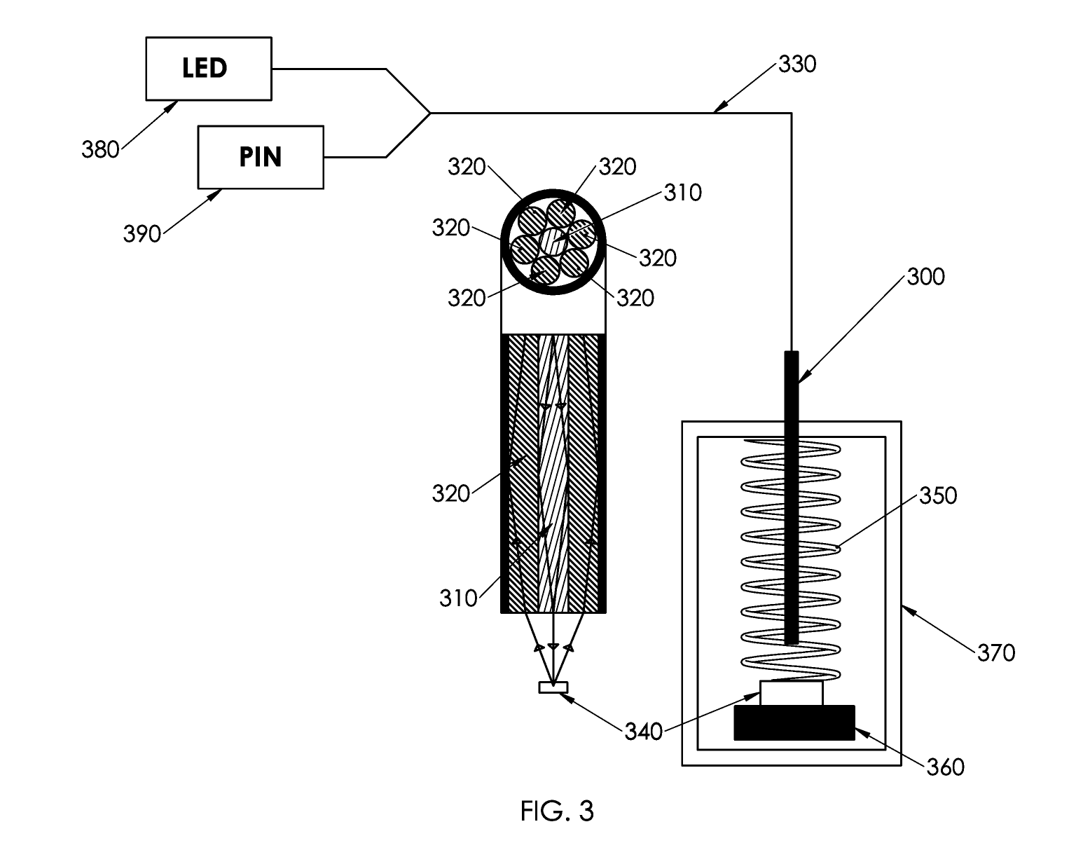

FIG. 3 illustrates an alternative embodiment of a fiber optic accelerometer 300 using a coil spring as the element responsive to the acceleration force and experiencing a displacement that is measured by the fiber optic probe. Using a spring coil as the element that displaces in response to acceleration is advantageous because of the well-known mechanical properties of spring coils in terms of their known spring force constants under various modes of construction and the linear response characteristics.

The following discussion about theoretical aspects of the sensors is provided for means of explanation of the spring coil sensor embodiment, without limiting the invention to any particular theory of operation. Under Hooke's law, F=−k*x, where F=force, k=the spring force constant characteristic of the spring, and x=displacement. Thus, a given acceleration force will displace the spring in a manner proportional to the spring constant of the particular spring coil chosen. This displacement can change the distance between the fiber probe and a reflector, which allows for measurement of the acceleration force. Since it is also know than F=m*a, where m=mass and a=acceleration, the displacement experienced by the spring can be related proportionally to acceleration. From this relationship it can be seen that the sensitivity of the spring is proportional to displacement over the accelerating force (x/a) which is also proportional to the mass over the spring force constant (m/k). Thus, increasing the mass while keeping the spring characteristics constant will improve the sensor's sensitivity, while increasing the stiffness of the spring will result in lower sensitivity assuming a constant mass.

An embodiment of the fiber optic accelerometer described in FIG. 3 may be constructed as follows. A coil spring 350 is selected. A mass 360 is added to the free end of the coil spring. The coil spring is then affixed to a housing 370 at the opposite end of the mass, while the opposite end of the spring is left free within the housing. The mass has a reflective surface 340 or reflective body attached to the mass that is attached to the free end of the spring.

A fiber bundle, consisting of the transmitting fiber 310 and one or more receiving fibers 320, is inserted into a tubing 330 so the fiber bundle are contained within the tube, forming a probe. Here, six receiving fibers 320 are used in the probe. The first end of the transmitting fiber may have a polished finish and the second end is coupled to a light source 380. The fiber ends of the at least one receiving fibers may have a polished finish and the second end(s) is coupled to a light detecting means 390. The sensor may use an LED emitting at 850μm as the light source 380 with a silicon PIN diode as the light sensing element 390. However, other light sources, such as laser diodes, and other light sensing elements may be used. The fiber optic probe 330 is positioned such that the first end of the transmitting fiber and the first end of each receiving fiber is adjacent to the reflective surface 340 of the mass 360 that is located at the free end of the spring 350. The fiber probe 330 and spring coil 350 may be affixed to the housing 370 for stability.

In operation, the force generated by acceleration causes a displacement in the spring coil in a direction relative to the fiber optic probe 330. The displacement in the spring 350 translates into a change in the distance between the fiber probe 330 and the reflective surface 340 of the mass. Light launched from the light source into the transmitting fiber propagates through the fiber, is reflected by the reflective surface attached to the mass, is received by the receiving fibers, and is detected by the light detecting means. This change in distance between the fiber probe and the reflector causes a change in the light received by the receiving fibers and detected by the light detector. The amount of detected light is indicative of acceleration experienced by the sensor.

An exemplary embodiment of the sensor depicted in FIG. 3 can be constructed as follows. A coil spring, constructed of stainless steel, with a length of 1.5″, an outer diameter of 0.0476″, an inner diameter of 0.0378″, and a wire diameter of 0.046″ is selected. A 2.5 g mass is added to the free end of the coil spring. The coil spring is then affixed to a housing at the opposite end of the mass, while the opposite end of the spring is left free within the housing. The mass has a reflective surface or body attached to the material that is used to add mass to the cantilever. The reflective surface or body attached to the material that is used to add mass to the cantilever. The reflective surface can be a metal (aluminum, beryllium, chromium, copper, gold, molybdenum, nickel, platinum, rhodium, silver, tungsten, and/or an alloy of any of these or other reflective metals) that is attached to the cantilever. The reflective surface may be attached to the cantilever by any known means, including by the use of an epoxy, or by evaporating or electroplating a reflective surface onto the cantilever.

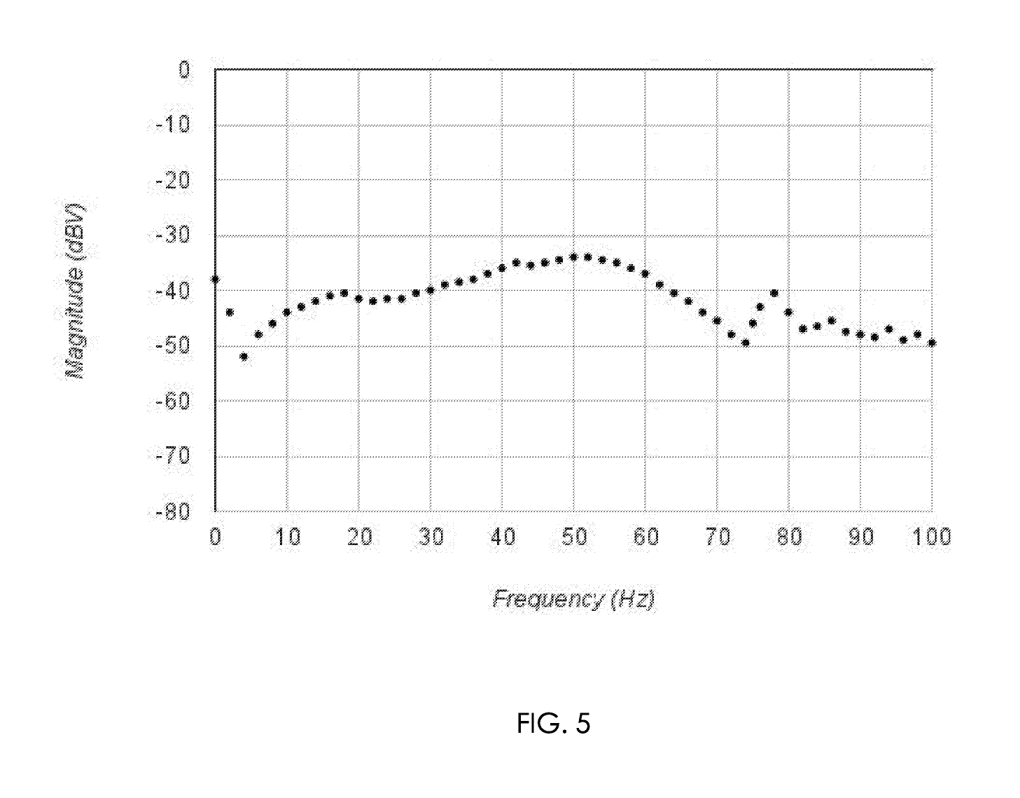

This experimental set-up described in FIG. 5 set up can be used to evaluate the sensor 300. The results of the experiment demonstrate that this sensor embodiment possesses a resonance frequency of 126 Hz and displays a sensitivity of 210 v/μm. The minimum detectable acceleration of this sensor embodiment is found to be 6.2×10⁻¹³ m/(Hz)^{1/2}. The resonant frequency for this sensor is comparable with the expected value as derived from the mass spring resonance frequency equation discussed above.

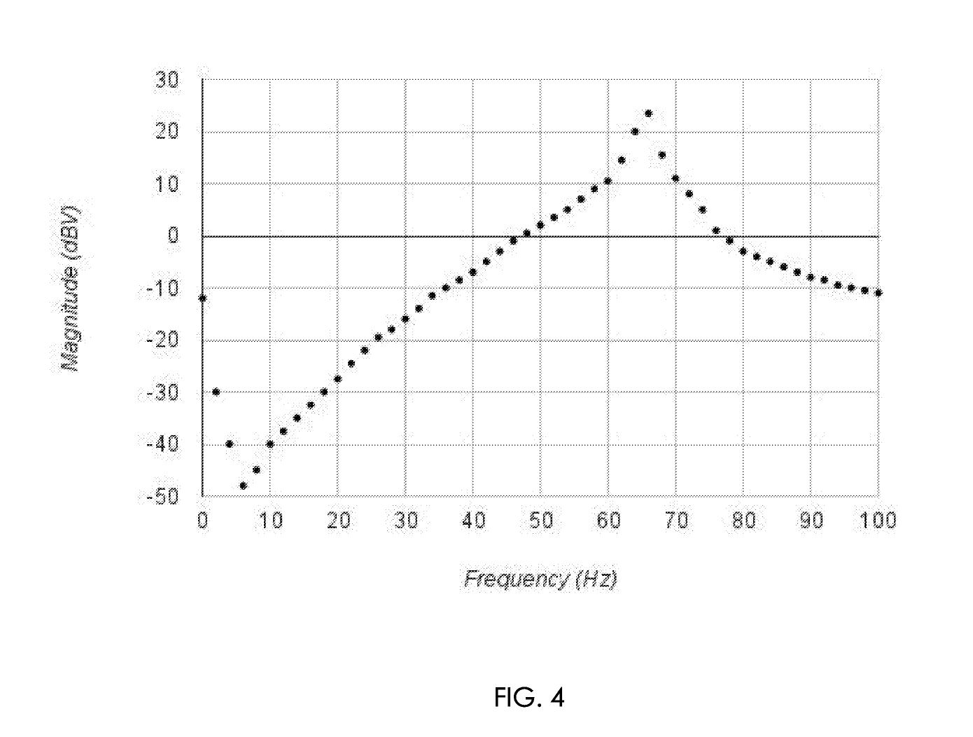

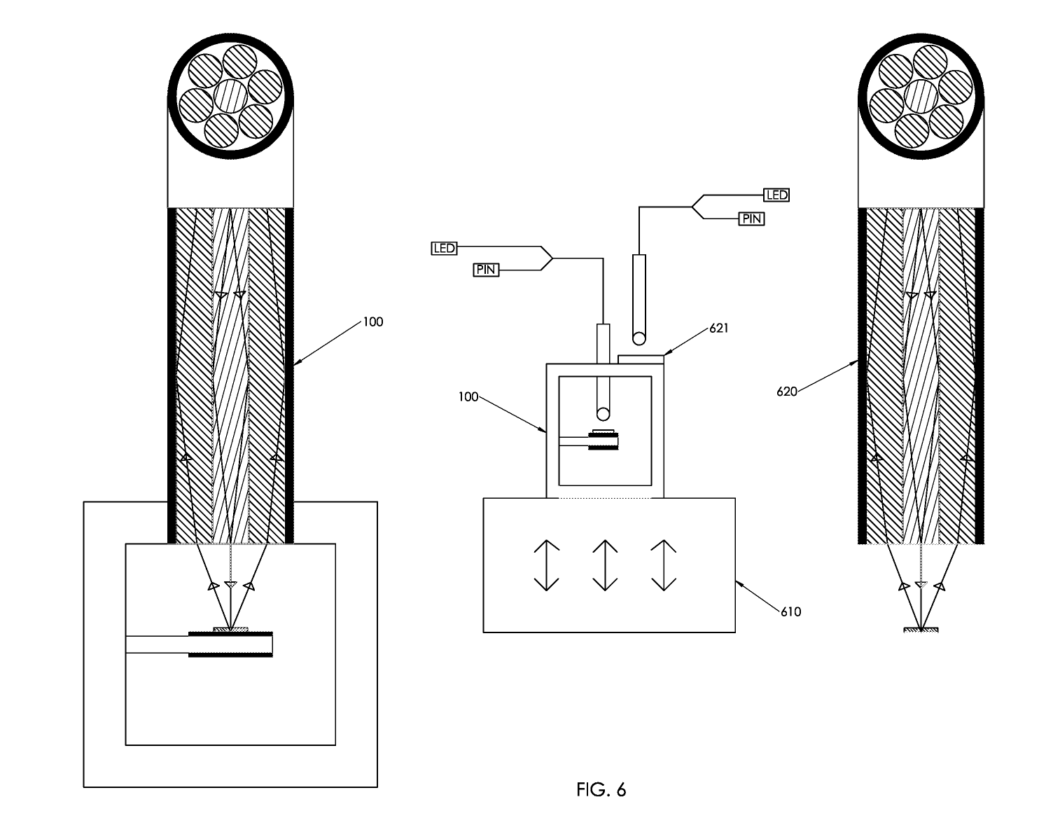

FIGS. 4 and 5 illustrate an evaluation of the sensor depicted in FIG. 1. FIG. 4 shows the voltage output response of the accelerometer of FIG. 1 over a frequency range of 0 Hz to 100 Hz. FIG. 6 shows an exemplary demonstration set-up used to obtain the results depicted in FIGS. 4 and 5 for the intensity modulated fiber optic acceleration sensor 100 disclosed in FIG. 1. The sensor 100 is mounted on an electromechanical vibrator 610. In this demonstration, the electromechanical vibrator is a Bruel and Kjaer model 4810 minishaker. The vibrator drives the sensor 100 so that the sensor cantilever element is displaced in the direction of the sensor reflector. As the sensor reflector displaces towards the sensor's fiber optic probe, the amount of light from the probe is modulated, as discussed in the paragraphs above. A fiber optic displacement probe 620 is also positioned upon the sensor 100. A reflective body 621 is affixed to the exterior housing of sensor 100, in a position to receive and reflect light from the fiber optic displacement probe 620. The distance between the reflector 621 and the end of the fibers in the fiber probe 620 can be set at a distance to optimize sensitivity. By comparing the voltage outputs of the sensor 100 and the displacement probe 520, the calibration of the sensor 100 can be verified.

This experimental set up can be used to evaluate the sensor 100, sample results of which are illustrated in FIGS. 3 and 4. By referring to the outputs illustrated at FIGS. 3 and 4, it can be seen that, at 30 Hz, for example, this sensor embodiment displays a sensitivity of 1670 v/μm. As can also be seen in FIG.4, the resonant frequency for the sensor embodiment described in FIG. 1 is at approximately 67 Hz, which is comparable with the expected value as derived from the mass spring resonance frequency equation discussed above. The minimum detectable acceleration of this sensor embodiment is 7.8×10⁻¹³ m/(Hz)^{1/2}.

The results of this experiment are also illustrated in FIG. 5, illustrating the displacement detected by the reference sensor over the 0 Hz to 100 Hz frequency range, as indicated by the voltage signal output of the reference sensor. This figure shows the displacement experienced by the fiber optic accelerometer at a given frequency, as indicated by the voltage signal output of the reference probe. The small dip shown in the experimental data at approximately 70 Hz may be due to imperfect adhesion between the reference sensor and the accelerometer. From this experiment, the sensor can be calibrated. From the above experiment, a calibration value of 8.35×10⁻⁶ cm/v was found using the seven-fiber displacement probe. Alternatively, an electronic reference accelerometer, such as an Endevco model 2250A can be utilized in place of the seven-fiber displacement probe 620 to calibrate of the sensor 100. Again, the reference displacement probe is positioned on top of the accelerometer sensor, in the direction of the movement to be sensed, with a reflective surface placed upon the top of the accelerometer, such that the displacement probe will receive and reflect light due to the movement experienced by the accelerometer.

An experiment was conducted upon an alternative sensor embodiment similar to that described in FIG. 1, but with modifications to its construction. The cantilever was constructed of bronze, with a length of 1.125″, a width of 0.25″, and a thickness of 0.005″. A mass of 2.5 g of brass was added to the cantilever end. By replicating the experiment performed upon the sensor described above, the resonant frequency of the modified sensor is decreased to 16 Hz, which is again consistent with the analytically derived value to be expected from the mass spring resonance frequency equation described above. At 30 Hz, for example, this sensor embodiment displays a sensitivity of 9600 v/μm. The minimum detectable acceleration of this sensor embodiment is found to be 1.37×10⁻¹⁴ M/(HZ)^{1/2}. As above, a calibration value of 8.35×10⁻⁶ cm/v was found using the seven-fiber displacement probe. It can therefore be seen that changing the construction of the cantilever can result in a decrease of in the resonant frequency, higher sensitivity, and lower minimum detectable displacement. As a result, changing the materials that compose the cantilever, adding mass to the cantilever (or otherwise changing the weight of the sensor), or changing the mechanical construction of the cantilever (i.e., using a cantilever with one free end, double cantilevered, quadruple cantilever, circular cantilever, etc.) will change the sensor's spring-mass resonance and sensitivity.

Changing the cantilever properties can also affect its performance. For example, an alternative sensor embodiment utilizing a dual cantilever was constructed. The cantilever element was constructed of mylar (length=2″ length, width 0.25″, thickness=0.0005″). Unlike the previous cantilever constructions, the dual cantilever has no free end and instead has each end affixed to the sensor housing. A 1 g mass of brass was added at the mid-point of the dual cantilever, with the reflective surface attached to the mass. The sensor embodiment was found to have a resonant frequency of 32 Hz and a sensitivity of 5400 v/μm at 20 Hz and 8500 v/μm at 50 Hz. As above, a calibration value of 8.35×10⁻⁶ cm/v was found using the seven-fiber displacement probe.

Although the sensors are described in relation to the exemplary embodiments described, it is well understood by those skilled in the art that other variations and modifications can be effected on the preferred embodiments without departing from the scope and spirit of the invention as set forth herein.

### Intensity Modulated Fiber Optic Acceleration Sensor System

Multiple fiber optic acceleration sensors can be used to create a system of fiber optic acceleration sensors, including the use of one or more seven-fiber intensity modulated acceleration sensors described above. The system provides a means for measurement of multiple acceleration signals, such as those experienced along different directional planes (i.e., perpendicular x, y, and z axes). A unique characteristic of the invention is that the system allow for multiple axes of acceleration inputs to be measured along a common plane of a structure (i.e., in a single direction). The system disclosed allows multiple sensors to measure acceleration along multiple axes on a common plane of an object of interest, enabling the sensor fibers to enter a common enclosure from the same direction, reducing the footprint of the overall sensor system.

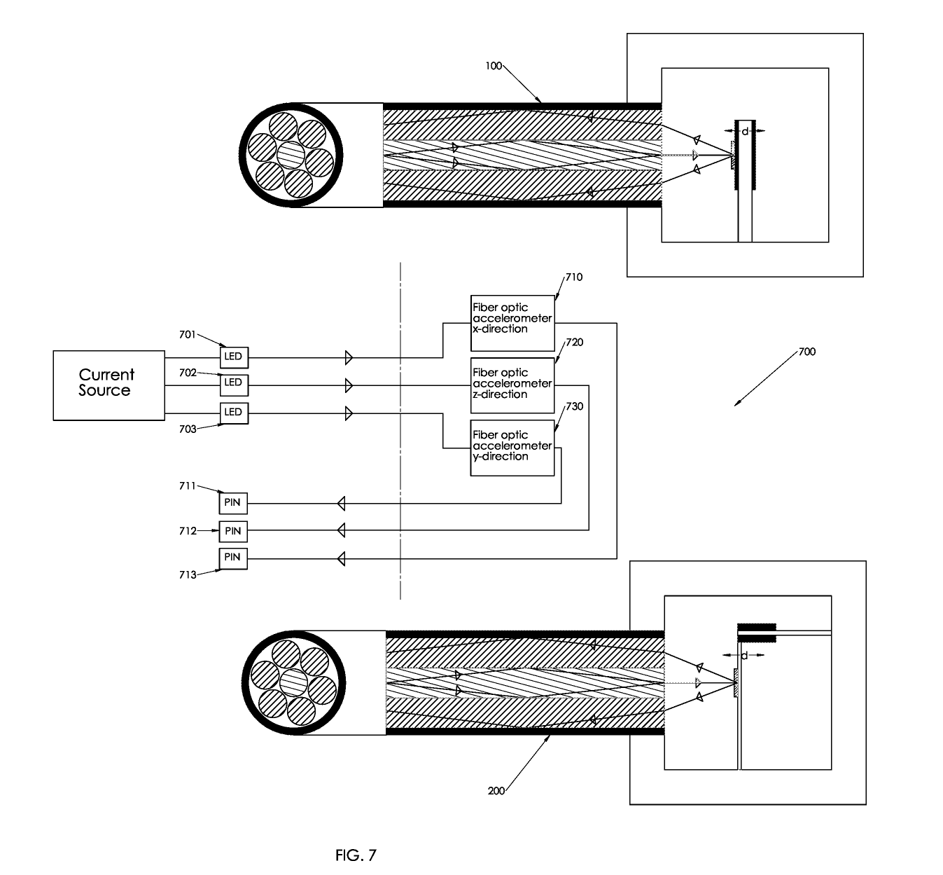

FIG. 7 illustrates an embodiment of a triaxial fiber optic sensor system 700 that can measure acceleration in three perpendicular axes. The system includes three seven-fiber cantilevered acceleration sensors 710, 720, and 730, such as those described in FIGS. 1 and 2. However, any combination of fiber optic accelerometers may be utilized. Here, the cantilevered sensors disclosed at FIGS. 1 and 2 are used to construct the system. In this example, the seven-fiber probe described in FIG. 1 is used to measure the x axis acceleration (corresponding to sensor 710), while the seven-fiber probe described in FIG. 2 are positioned such that they measure the acceleration forces experiences upon the y and z direction axes (corresponding to sensor 720 and 730), by translating the acceleration signals experienced upon those axes onto the x axis using the alternative cantilever embodiment presented in FIG. 2.

In the embodiment presented in FIG. 7, the sensors are arranged within a common housing, but are arranged so that one sensor measures acceleration in the x direction, a second sensor measures acceleration in the y direction, and the third measures acceleration in the z direction. The sensors are selected and arranged so that motion of the enclosure causes the cantilever of each sensor to be displaced towards the fiber optic probe of each sensor: one to be displaced in the x direction, the y direction, and the z direction.

The cantilevers and fiber probes of the sensor are arranged so as to allow the three fiber probes to enter and exit a common enclosure or housing from the same direction, allowing for a compact housing to be constructed and reducing the overall space footprint of the system. The transmitting fibers leading to the sensors 710, 720, and 730 can be bundled together on the outside of the enclosure, and can pass through the same opening or different openings in the enclosure. The enclosure or housing for the sensor is affixed to the structure whose acceleration is to be measured.

Light is launched from a light source 701, 702, and 703 to each fiber optic sensor of the system through the sensors' transmitting fiber. Here, the light source is at least one LED. The light is reflected off of the reflective body attached to the cantilever and into the receiving fiber(s) of each sensor. The light travels through each sensor's receiving fibers to a light detecting means 711, 712, 713. Here, the light detecting means is a PIN photodetector. The output signal from the photodetector indicating the light received by the receiving fiber is proportional to the change in distance between the reflector at the free end of the cantilever and the fiber probe for each sensor. Other sensors embodiments may be used, including (without limitation) two-fiber and three-fiber acceleration sensors. The intensity of the reflected light received in the receiving fibers indicates the acceleration or displacement of the cantilevered reflector in the x, y, and z directions.

The system may also incorporate measurements of pressure, strain, electromagnetic phenomena, displacement, temperature, or other physical phenomena. The use of multiple sensors using a common system also allows for the measurement of multiple physical phenomena in addition to acceleration, which can include pressure, strain, displacement, temperature, electromagnetic phenomena, or other physical phenomena, and in combination with one another. Thus, the system disclosed provides a means for taking multiple measurements of acceleration or displacement phenomena at the same (or approximately the same) location or in multiple locations. Embodiments of the multiplexed acceleration sensor system can be constructed so as to use additional types of fiber optic sensors to take different kinds of measurements at the same location or approximately the same location.

Because a large number of sensors that may be desirable to take multiple measurements of interest, it is further advantageous to multiplex them in order to reduce the number of total components required to construct the system. FIG. 7 illustrates a multiplexed acceleration triaxial sensor system according to an embodiment of the invention. In this embodiment a single current source can support several LEDs, which can each provide light to a fiber optic accelerometer. In alternative embodiments, each LED can supply light to multiple multimode optical fibers and each of these multimode optical fibers supplies light to a sensor. For example, a larger diameter multimode fiber can be optically connected to six 200 micron diameter fibers in the manner disclosed in U.S. Pat. No. 7,379,630 to Lagakos et al., the disclosure of which is incorporated herein in its entirety. In this manner, each LED can optically support thirty six accelerometers. Combinations of different types of sensors can be included in the systems shown in FIG. 7. For example, it is suitable to include both cantilevered and coil spring fiber optic accelerometers.

In addition, fiber optic sensors responsive to strain, acceleration, dynamic or static pressure, temperature, electromagnetic phenomena, displacement or other parameters, can also be included in the system. U.S. Pat. No. 7,379,630 to Lagakos et al. illustrates a sensor system in which each LED drives six fiber optic sensors and identifies suitable components for the sensors and sensor devices, although it will be recognized that many other components may also be used.

Although this invention has been described in relation to the exemplary embodiments, it is well understood by those skilled in the art that other variations and modifications can be effected on the preferred embodiments without departing from the scope and spirit of the invention as set forth herein.

The invention claimed is:

1. A fiber optic sensor for measuring acceleration, comprising:
an optical fiber probe including
at least one transmitting fiber having one end coupled to a light source and at least
one receiving fiber having one end coupled to a light sensing means;
a cantilever that experiences a physical displacement in response to acceleration, the cantilever being reflective or having a reflective surface or a reflective body attached thereto;
the fiber probe being positioned such that the uncoupled end of the fibers are adjacent to the reflective surface of the cantilever with space between the fibers and the reflective surface;
wherein, light transmitted through the transmitting fiber emerges at the uncoupled end, propagates a short distance, and is reflected by the reflective surface into the at least one receiving fiber, and is detected by a light sensing means, upon the movement of the cantilever in response to acceleration, the distance between the fiber probe and cantilever changes which modulates the amount of light reflected into the at least one receiving fiber.

2. The sensor in claim 1, wherein the fiber optic probe comprises a single transmitting and receiving fiber, with one end being coupled to a light source and a light sensing means and the second end being adjacent to the reflective surface with space between the fiber and the reflective surface of the cantilever.

3. The sensor of claim 1, wherein a plurality of receiving fibers are used.

4. The sensor of claim 1, wherein the at least one receiving fibers consist of six fibers arranged surrounding the transmitting fiber.

5. The sensor of claim 1, further comprising the light source.

6. The sensor in claim 5, wherein the light source is a light emitting diode or a laser.

7. The sensor of claim 1, further comprising the light detecting means.

8. The sensor in claim 7, wherein the light detecting means is at least one of a PIN detector, a photodiode, a photomultiplier tube, or a semiconductor-metal detector.

9. The sensor in claim 1, further comprising a housing that encloses the fiber optic probe and the cantilever.

10. The sensor in claim 1, wherein the distance between the fiber probe and the reflective surface of the cantilever is in a range of 0 to 500 microns.

11. The sensor of claim 1 wherein the cantilever has reflective layer or coating to enhance its light reflective properties.

12. The sensor of claim 1 wherein an additional mass is added to the cantilever to change the sensor's acceleration detection characteristics.

13. The sensor of claim 1 wherein the cantilever is affixed to a housing enclosing the cantilever and the optical fiber probe.

14. The sensor of claim 1 wherein the cantilever is anchored at one end and has one free end.

15. The sensor of claim 1 wherein the cantilever is anchored at two ends.

16. The sensor of claim 1 wherein the cantilever is anchored at more than two ends.

17. The sensor of claim 1 wherein the cantilever is constructed as a circular membrane.

18. A fiber optic sensor for measuring acceleration, comprising:
an optical fiber probe including at least one transmitting fiber having one end coupled to a light source and at least one receiving fiber having one end coupled to a light sensing means;
a cantilever that experiences a physical displacement in response to acceleration;
a material being attached to the cantilever that is reflective or has a reflective surface or a reflective body attached thereto;
wherein the material affixed to the cantilever is constructed in a manner wherein the material displaces proportionally and in a direction perpendicular to the physical displacement experienced by the cantilever in response to acceleration;
the fiber probe being positioned such that the uncoupled ends of the fibers are adjacent to the reflective surface of the material attached to the cantilever with space between the fibers and the reflective surface;
wherein, light transmitted through the transmitting fiber emerges at the uncoupled end, propagates a short distance, and is reflected by the reflective surface of the material into the at least one receiving fiber, and is detected by a light sensing means, upon the movement of the cantilever in response to acceleration, the material attached to the cantilever displaces in a direction relative to the fiber optic probe, and the change in the distance modulates the amount of light reflected into the at least one receiving fiber.

19. The sensor of claim 18 wherein the material attached to the cantilever has a reflective layer or coating to enhance its light reflective properties.

20. A fiber optic sensor system, comprising:
at least one light source,
a plurality of optical fibers arranged to receive light from the light source,
at least one fiber optic sensor for measuring acceleration,
with each of the optical fibers transmitting light to one of the fiber optic sensors.

21. The sensor system according to claim 20, comprising three fiber optic acceleration sensors, arranged so as to measure acceleration forces along multiple axes.

22. The sensor system according to claim 20, further comprising at least one other fiber optic sensor which is a static or dynamic pressure sensor, strain sensor, electromagnetic phenomena sensor, displacement sensor, acceleration sensor, or temperature sensor.

23. A system of intensity modulated fiber optic sensors for detecting low frequency acceleration signals, comprising:
at least two intensity modulated fiber optic sensors, including at least one fiber optic accelerometer;
at least one light source;
at least one light sensing element for each sensor;
at least one optical fiber arranged to transmit light from the light source to each fiber optic sensor;
at least one optical fiber arranged to transmit light from each fiber optic sensor to its light sensing element; and
a processor that receives the electrical signal outputs from the light sensing element and converts the signals into an output of the measured acceleration, with the system taking measurement of acceleration signals with at a frequency of lower than 100 Hz.

24. The system according to claim 23, further comprising an analog-digital converter to convert the electrical signal output of the light sensing element to a digital format.

25. The system according to claim 23 further comprising at least one additional fiber optic accelerometer spaced apart from the first fiber optic accelerometer to detect the presence of low frequency acceleration signals produced by seismic events on multiple structures, at multiple locations, or at an approximately common location.

26. The system according to claim 23, wherein the processor further compares the output difference between the signals generated by at least two fiber optic accelerometers at one or more locations to determine characteristics of the seismic event of interest.

27. The system according to claim 23, wherein the system measures current in the operating range between 0 and 250 Hz.

28. A fiber optic sensor for measuring acceleration, comprising:
an optical fiber probe including at least one transmitting fiber having one end coupled to a light source and at least one receiving fiber having one end coupled to a light sensing means;
a spring that experiences a physical displacement in response to acceleration;
a material attached to the spring that is reflective or has a reflective surface or a reflective body attached thereto;
wherein the spring and reflective material displace proportionally to acceleration, with the fiber probe being positioned such that the uncoupled ends of the fibers are adjacent to the reflective surface of the material attached to the spring with space between the fibers and the reflective surface;
wherein, light transmitted through the transmitting fiber emerges at the uncoupled end, propagates a short distance, and is reflected by the reflective surface of the reflective material into the at least one receiving fiber, and is detected by a light sensing means, upon the movement of the spring in response to acceleration, the change in the distance between the material and the fiber optic probe modulates the amount of light reflected into the at least one receiving fiber.
